(19) United States
(12) Patent Application Publication
(10) Pub. No.: US 2007/0295031 A1
(43) Pub. Date: Dec. 27, 2007

(54) Glass molding machine and glass molding method

(75) Inventor: Masanori Utsugi, Saitama-shi (JP)

Correspondence Address: BIRCH STEWART KOLASCH & BIRCH, PO BOX 747, FALLS CHURCH, VA, 22040-0747, US

(73) Assignee: Fujinon Corporation

(21) Appl. No.: 11/812,736

(22) Filed: Jun. 21, 2007

(30) Foreign Application Priority Data
Jun. 23, 2006 (JP) P2006-173609

(51) Int. Cl. C03B 11/08; C03B 11/00

(52) U.S. Cl. 65/39; 65/357

(57) ABSTRACT

A glass molding machine includes a shaping die, a temperature controller, a die assembling state, a glass molding stage and a die disassembling stage. The shaping die includes a first, second and body molds. The die assembling stage feeds a glass material to the first mold with the body mold being fitted to the exterior of the first mold. The die assembling stage fits the second mold to the body mold to assemble the shaping die. The glass molding stage heats and molds the glass material. The die disassembling stage removes the second mold from the body mold after the molding, to remove the molded glass product. The temperature controller provides a temperature difference so that a temperature of the body mold is higher than a temperature of the second mold in the die assembling stage and in the die disassembling stage.

### BACKGROUND OF THE INVENTION

1. Technical Field

The invention relates to a glass molding machine and a glass molding method and, more particularly, a glass molding machine and a glass molding method capable of smoothly assembling and disassembling a die.

2. Description of the Related Art

Nowadays a higher accuracy and a higher resolution are required of the optical parts such as an optical lens to improve optical performances such as performance regarding providing of precise depiction. For this reason, in order to suppress misalignment of the optical axis as close to zero as possible, for example, it is desirable that a clearance between (i) an upper mold and a lower mold and (ii) a body mold should be set to the minimum at a time of heating/molding in a glass molding step.

On the other hand, when the clearance is set to the minimum, it is difficult to take out/put in the molds in assembling and disassembling the die. More particularly, when the mold is taken out/put in, a worker must move the mold to take it out/put it in while holding it vertically within a range of the clearance. When the mold leans to one side, the mold may not be moved because of engagement of its sliding face or damage of the sliding face. As a result, there existed such problems that the clearance is increased and it is difficult to ensure a positional accuracy repeatedly.

Therefore, various technologies to perform a die assembling and a die disassembling by ensuring a clearance necessary for the die assembling and the die disassembling while maintaining a molding accuracy are disclosed (JP Hei. 9-188529 A (claim 1)).

The technologies disclosed in JP Hei. 9-188529 A attempt to solve this problem in such a manner that the shaping die is formed of a lower mold, a body mold fitted into the lower mold, and an upper mold to be fitted into the body mold and that mold materials of the lower mold and the body mold are smaller in coefficient of linear expansion than a mold material of the upper mold.

In other words, the clearance is set to have the minimum clearance in a high temperature state during the molding, and then the clearance larger than that kept during the molding is ensured in such a manner that a shrinkage rate of the upper mold (core side) is set larger than those of the lower mold and the body mold (hold side) in a state where a temperature of the die falls in the die assembling and the die disassembling.

However, when the mold materials having different coefficients of linear expansion are used in (i) the upper mold and (ii) the lower mold and the body mold, the clearance varies depending on change in temperature during pressurizing/molding operations. Therefore, there were the problems that a misalignment and inclination of the optical axis in moldings are caused due to the change in temperature, which adversely affects a molding accuracy.

In particular, for example, a product is molded so that the molding temperature is increased up to about 620° C. to exceed a transition point (phase transition from a solid to a liquid, about 500° C. by way of example) of a glass material in the pressurizing/molding operations and then the molding temperature is decreased gradually around the transition point. For this reason, there existed the problems that the clearance of the shaping die also varies depending on such change in temperature (in this example, 120° C.) in the pressurizing/molding operations and thus the minimum clearance cannot be maintained during the molding.

In other words, in a situation that the clearance is set so that the minimum clearance is obtained at 620° C., the clearance is increased correspondingly when the molding temperature falls to the transition point. Therefore, a molding accuracy is adversely influenced. In contrast, in a situation that the clearance is set so that the minimum is obtained at the transition point, the clearance would disappear at 620° C. Therefore, there is a risk that trouble such as seizure is caused on the sliding face.

### SUMMARY OF THE INVENTION

The invention has been made in view of such circumstances, and provides a glass molding machine and a glass molding method capable of smoothly assembling and disassembling a die while making sure of a molding accuracy.

[1] In order to solve the problem, according to an aspect of the invention, a glass molding machine includes a shaping die, a temperature controller, a die assembling stage, a glass molding stage and a die disassembling stage. The shaping die includes a first mold, a second mold and a body mold. The first and second molds are to be assembled with facing each other. The body mold is to be fitted to exteriors of the first and second molds to position the first and second molds. The glass molding machine heats and molds a glass product from a glass material by using the shaping die. The die assembling stage feeds the glass material to the first mold with the body mold being fitted to the exterior of the first mold. The die assembling stage fits the second mold to the body mold to assemble the shaping die. The glass molding stage heats and molds the glass material. The die disassembling stage removes the second mold from the body mold after the molding, to remove the molded glass product. The temperature controller provides a temperature difference so that a temperature of the body mold is higher than a temperature of the second mold in the die assembling stage and in the die disassembling stage.

According to the above configuration, the temperature controller provides a temperature difference so that a temperature of the body mold is higher than a temperature of the second mold in the die assembling stage and in the die disassembling stage. Thereby, an inner diameter of the body mold as a hole side becomes larger than an outer diameter of the upper mold as a core side due to a thermal expansion caused by this temperature difference. Thus, the clearance between the body mold and the upper mold can be expanded.

Therefore, not only a molding accuracy can be ensured by keeping a predetermined minimum clearance at a time of molding, but also the die assembling/disassembling operations can be carried out smoothly by expanding the clearance at a time of assembling/disassembling the mold.

Here, the term “temperature difference” is used as a broad concept including a “temperature gradient.”

### [2] In the glass molding machine of [1], the first mold, the second mold and the body mold may be formed of a molding material having a substantially identical coefficient of linear expansion.

According to such a configuration, because the temperature conditions of the first mold, the second mold, and the body mold are substantially identical, the clearance can be maintained constant as it is even when the molding temperature is changed. Therefore, a molding accuracy can be ensured.

### [3] In the glass molding machine of [1] or [2], the temperature controller may include a heating/heat-retention device that heats the body mold or keeps the temperature of the body mold.

According to such a configuration, the heating/heat-retention device that heating the body mold or keeps the temperature of the body mold is provided. Therefore, the temperature difference between the body mold and the second mold can be provided effectively with the configuration that is simpler than the configuration used to cool the second mold.

### [4] In the glass molding machine of any of [1] to [3], the temperature controller may include a cooling device that cools the second mold.

According to such a configuration, the second mold can be cooled while heating the body mold, for example. Therefore, the temperature difference can be provided quickly.

### [5] In the glass molding machine of any one of [1] to [4], the first mold may be a lower mold, and the second mold may be an upper mold.

According to such a configuration, the glass material is fed to the lower mold and then the body mold fitted to the exterior of this lower mold is heated. Therefore, a heat shock of the glass material can be lessened by warming the lower mold side to which the glass material is fed.

[6] According to another aspect of the invention, a glass molding machine includes a shaping die, a glass material feeding device, a die assembling device, a heating/molding device, a die disassembling device, a glass product removing device and a shaping-die conveying device. The shaping die includes a first mold, a second mold and a body mold. The first and second molds are to be assembled with facing each other. The body mold is to be fitted to exteriors of the first and second molds to position the first and second molds. The glass molding machine heats and molds a glass product from a glass material by using the shaping die. The glass material feeding device feeds the glass material to the first mold with the body mold being fitted to the exterior of the first mold. The die assembling device fits the second mold to the body mold to assemble the shaping die. The heating/molding device heats and molds the glass material using the shaping die assembled by the die assembling device. The die disassembling device removes the second mold from the body mold after the heating/molding device heats and molds, to disassemble the shaping die. The glass product removing device removes the glass product from the first mold and the body mold from which the second mold is removed. The shaping-die conveying device carries the shaping die between (i) the die assembling device and the die disassembling device and (ii) the heating/molding device. The die assembling device and the die disassembling device include a temperature controller that provides a temperature difference so that a temperature of the body mold is higher than a temperature of the second mold.

According to such a configuration, the glass molding machine is provided with the glass material feeding device that feeds the glass material, the die assembling device that assembles the shaping die, the heating/molding device that heats and molds the glass material, the die disassembling device that disassembles the shaping die, the glass product removing device that removes the glass product, and the shaping-die conveying device that carries the shaping die. Thereby, the step of feeding the glass material to the step of removing the glass product can be automated.

Also, the die assembling device and the die disassembling device includes the temperature controller that provides the temperature difference so that the temperature of the body mold is higher than the temperature of the second mold. Thus, an inner diameter of the body mold as a hole side becomes larger than an outer diameter of the upper mold as a core side due to a thermal expansion caused by this temperature difference. Therefore, the clearance between the body mold and the upper mold can be expanded.

Therefore, not only a molding accuracy can be ensured by keeping a predetermined minimum clearance at a time of molding, but also the die assembling/disassembling operations can be carried out smoothly by expanding the clearance at a time of assembling/disassembling the mold.

In this case, the die assembling device and the die disassembling device may be provided as separate devices. Alternatively, a common device may be used as the die assembling device and the die disassembling device.

[7] According to further another aspect of the invention, a glass molding method heats and molds a glass product from a glass material with using a shaping die including a first mold, a second mold and a body mold. The first and second molds are to be assembled with facing each other. The body mold is to be fitted to exteriors of the first and second molds to position the first and second molds. The method includes: feeding the glass material to the first mold with the body mold being fitted to the exterior of the first mold and fitting the second mold into the body mold to assemble the shaping die; heating and molding the glass material; and removing the second mold from the body mold after the molding, to remove the molded glass product. The assembling and the removing include providing a temperature difference so that a temperature of the body mold is higher than a temperature of the second mold.

### [8] In the glass molding method of [7] the providing of the temperature difference may include heating the body mold or keeping the temperature of the body mold.

### [9] In the glass molding method of [7] or [8], the providing of the temperature difference may include cooling the body mold.

### [10] In the glass molding method of any one of [7] to [9], the glass product may be an optical element, and the temperature difference may be in a range of 150° C. to 250° C.

In this manner, the temperature difference between the second mold and the body mold is in the range of 150° C. to 250° C. Therefore, the necessary and sufficient clearance can be ensured, and the die assembling and the die disassembling can be performed smoothly.

### [11] In-the glass molding method of anyone of [7] to [10], the first mold may be a lower mold, and the second mold may be an upper mold.

According to the glass molding machine and the glass molding method set forth above, the glass molding machine and the glass molding method capable of smoothly assembling and disassembling the die while making sure of a molding accuracy can be provided.

### BRIEF DESCRIPTION OF THE DRAWINGS

FIG. 1 is a schematic plan view showing an overall configuration of a glass molding machine according to an embodiment of the invention.

FIG. 2 is a front view of the machine in FIG. 1.

FIG. 3 is a schematic section view explaining operations of a die assembling/disassembling device.

### DETAILED DESCRIPTION OF EMBODIMENTS OF THE INVENTION

Exemplary embodiments of the invention will be explained below in detail while referring appropriately to the drawings.

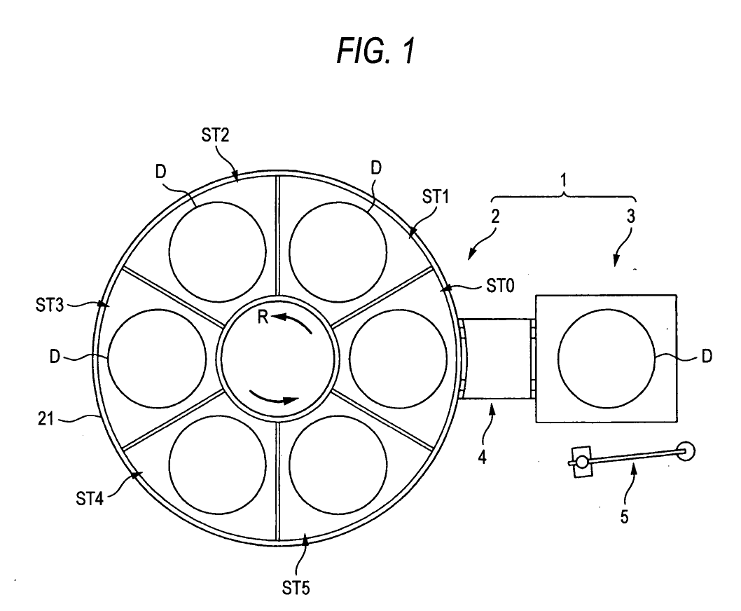

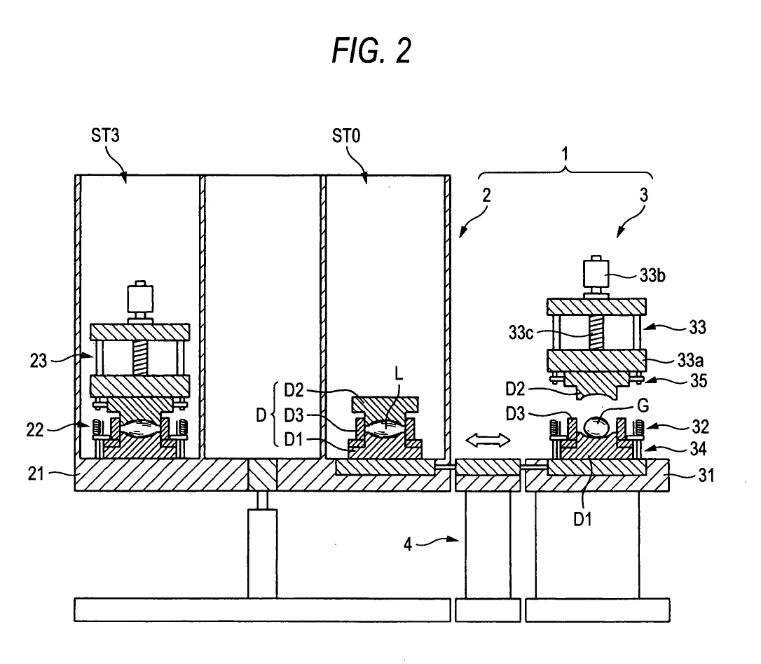

In the drawings to be referred to, FIG. 1 is a schematic plan view showing an overall configuration of a glass molding machine according to an embodiment of the invention, and FIG. 2 is a front view of the machine in FIG. 1.

In this embodiment, the case where an optical lens L as a glass product is manufactured by a glass molding machine 1 will be explained by way of example.

As shown in FIG. 1, the glass molding machine 1 according to the embodiment of the invention includes a molding machine main body 2 as a heating/molding machine, a die assembling/disassembling device 3 that assembles and disassembles (i) a lower mold D1 and a body mold D3 and (ii) an upper mold D2 (shaping die D, see FIG. 2), a shaping-die conveying device 4 that carries the shaping die D between the die assembling/disassembling device 3 and the molding machine main body 2, and a feeding/removing device 5 that feeds a glass material G (see FIG. 2) and removes a glass product.

Here, the feeding/removing device 5 is provided with a robot hand, for example. Also, a glass material feeding device that feeds the glass material G (see FIG. 2) and a glass product removing device that removes the molded optical lens L are integrated to constitute the single feeding/removing device 5. However, the feeding/removing device 5 is not limited to this configuration. The glass material feeding device and the glass product removing device may be constructed as individual devices, and may be placed in separate locations.

As shown in FIG. 1, the molding machine main body 2 has, for example, a loading/unloading stage ST0 that loads and unloads the shaping die D (see FIG. 2), a heating stage ST1 that heats the shaping die D and the glass material G (see FIG. 2) fed into a cavity of the shaping die D, pressurizing/molding stages ST2, ST3 that heat and mold the glass material G while applying pressure thereto, an slowly cooling stage ST4 that curing the glass material G while slowly cooling the glass material G, and a cooling stage ST5 that cools the glass material G naturally to a temperature at which a composition of the glass stables.

Also, the molding machine main body 2 molds the optical lens L (see FIG. 2) as the glass product from the glass material G (see FIG. 2), while forwarding the shaping die D that is put on a turntable 21 to the respective stages sequentially.

Next, steps performed in the respective stages will be explained briefly below.

The shaping die D is moved from the loading stage ST0 to the heating stage ST1 according to a movement of the turntable 21. In this heating stage ST1, a temperature of the shaping die D is increased rapidly by a heating unit 22 (see FIG. 2) to exceed the transition point (e.g., 620° C.) of the glass material G or more. In the pressurizing/molding stages ST2, ST3, the optical lens L is molded by a pressurizing device 23 (see FIG. 2) while the temperature of the shaping die D is kept at the transition point or more. In the slowly cooling stage ST4, the molding temperature is decreased gently to the vicinity of the transition point while the shaping die D is heated so that the molding temperature does not fall suddenly. Then, in the cooling stage ST5, the shaping die D is naturally cooled to the temperature at which a composition of the glass is stabilized. Then, the shaping die D is moved to the unloading stage ST0.

In this embodiment, the above stage configuration is employed. However, the invention is not limited to this configuration. The configuration may be changed in response to the material of the glass material G and a product shape. Also, in this embodiment, the turntable system is employed. However, the invention is not limited to this configuration. The linear moving system may be employed.

Also, in this embodiment, the loading/unloading stage ST0 for the shaping die D provided in the molding machine main body 2 is constructed as a common stage. However, the invention is not limited to this configuration. The loading stage and the unloading stage may be provided separately in an inlet side and an exit side, respectively.

Next, the shaping die D used in the glass molding machine 1 will be explained below.

As shown in FIG. 2, the shaping die D includes the lower mold D1 and the upper mold D2, which are assembled with facing each other, and the body mold D3 fitted to exteriors of the lower mold D1 and the upper mold D2 to position the lower mold D1 and the upper mold D2. Then, in a state where the shaping die D is closed, the lower mold D1, the upper mold D2 and the body mold D3 form the cavity and the optical lens L is heated and molded therein.

Also, the lower mold D1, the upper mold D2 and the body mold D3 constituting the body mold D3 are made of a hard metal for a precision mold as molding materials, and have substantially the same coefficient of linear expansion. Therefore, even if a temperature of the shaping die D is changed, the clearance can be maintained constant as it is so long as the lower mold D1, the upper mold D2, and the body mold D3 are held at the same temperature.

In this embodiment, the shaping die D is constructed by the lower mold D1, the upper mold D2, and the body mold D3, and also the body mold D3 is fixed on the lower mold D1 side. However, the invention is not limited to this configuration. The body mold D3 may be fixed on the upper mold D2 side. Also, in this embodiment, the body mold D3 is constructed as a separate body from the lower mold D1 and the upper mold D2. However, the invention is not limited to this configuration. The body mold D3 may be integrated with the lower mold D1 or the upper mold D2.

As shown in FIG. 2, the die assembling/disassembling device 3 is arranged on the outside of the loading/unloading stage ST0 of the molding machine main body 2 and is adjacent to the molding machine main body 2 with being arranged across the shaping-die conveying device 4 from the molding machine main body 2.

The die assembling/disassembling device 3 includes a mold table 31 on which the lower mold D1 is put on, a heating/temperature-retention device 32 which may serve as a heating/heat-retention device of a temperature controller and which are arranged so as to heat the body mold D3, and an elevating device 33 that can move up and down the upper mold D2 in the vertical direction.

Also, a lower clamping device 34 that clamps the lower mold D1 is arranged on the mold table 31, and an upper clamping device 35 that clamps the upper mold D2 is arranged on an elevating plate 33a of the elevating device 33.

A high frequency heating device of the non-contact high frequency induction heating system may be employed as an example of the heating/temperature-retention device 32. This high frequency heating device is suitable because it can heat directly the body mold D3 as a heated object. Of course, the heating/temperature-retention device is not limited to the high frequency heating device. A heat block, a lamp heating system, or the like may be employed.

Also, the heating/temperature-retention device is not limited to the heating device. A heat-retention device that uses a heat insulation material such as glass wool may be employed. For example, in a state where a heat still remained after the shaping die D passes through the cooling stage ST5 (FIG. 1), only the temperature of the lower mold D1 side may be retained while the upper mold D2 side is cooled naturally to thereby provide a temperature difference between the body mold D3 and the upper mold D2.

The elevating device 33 includes the elevating plate 33a to which the upper mold D2 is fitted, a motor 33b as a driving source that moves the elevating plate 33a up and down, and a feed screw mechanism 33c that converts a rotation force of the motor 33b into a reciprocating motion.

In this embodiment, the elevating device 33 is configured so that the upper mold D2 is moved up and down with respect to the lower mold D1 to taken out/put in the upper mold D2. However, the invention is not limited to this configuration. The elevating device 33 may be configured so that the lower mold D1 and the body mold D3 are moved up and down with respect to the upper mold D2 to taken out/put in the upper mold D2.

The shaping-die conveying device 4 includes, for example, a driving device (not shown) and a carrying guide. For example, a fluid cylinder such as an air cylinder is employed as the driving device. The shaping-die conveying device 4 may be constructed by providing a linear guiding mechanism to this fluid cylinder. However, the invention is not limited to this configuration. Also, a servo motor, or the like may be employed as the driving source, and the shaping-die conveying device 4 may be constructed by combining this servo motor with the ball screw and the linear guiding mechanism. In short, various modes of the shaping-die conveying device 4 may be employed adequately in response to the configurations of the loading/unloading stage ST0 and the die assembling/disassembling device 3.

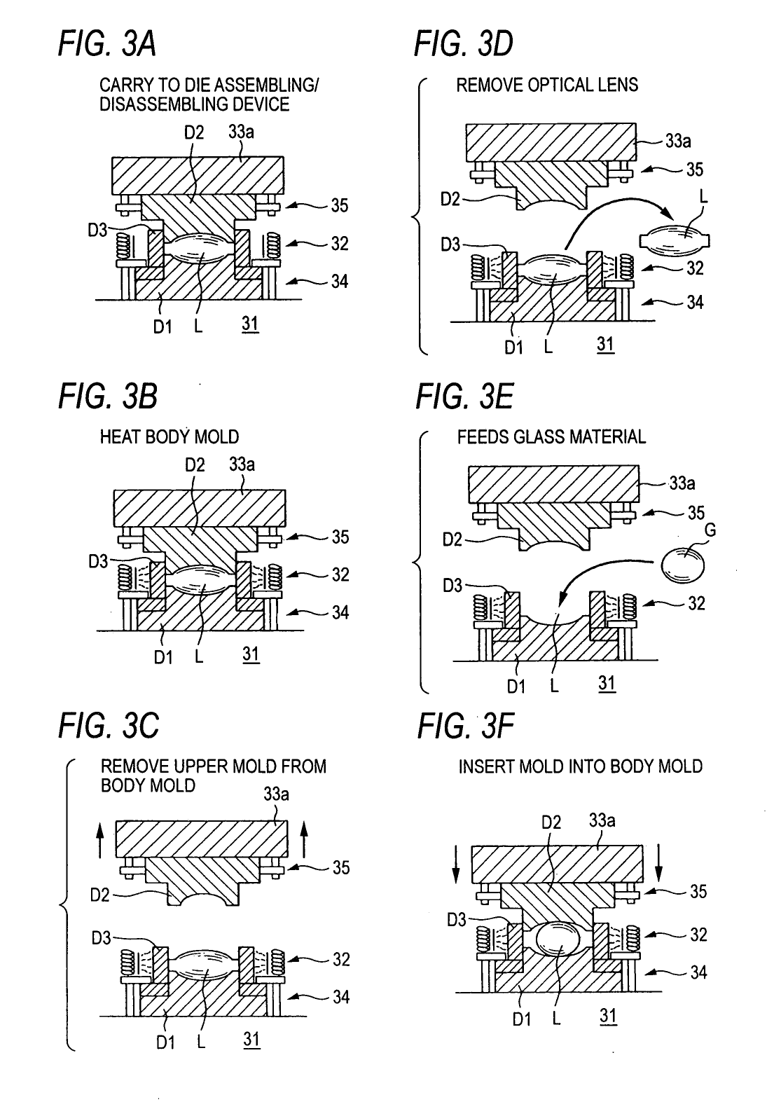

Next, operations of the glass molding machine 1 according to the embodiment of the invention configured as above will be explained below with reference to FIG. 3 mainly. FIG. 3 is a schematic section view explaining operations of the die assembling/disassembling device.

In the glass molding machine 1 according to the embodiment of the invention, as shown in FIG. 1, the shaping die D is carried into the loading/unloading stage ST0 from the die assembling/disassembling device 3. Then, when the turntable 21 is turned in the turning direction R, the shaping die D is transferred in sequence from the heating stage ST1 to the pressurizing/molding stages ST2, ST3, the slowly cooling stage ST4, and the cooling stage ST5. As a result, the optical lens L is molded. Thus, the shaping die D circulates through the respective stages ST0 to ST5, and again reaches the loading/unloading stage ST0.

When the shaping die D reaches the loading/unloading stage ST0 through the respective stages ST0 to ST5, the lower mold D1, the body mold D3 and the upper mold D2 are closed as shown in FIG. 2, and the optical lens L is molded in the closed cavity. Then, the shaping die D that has reached the loading/unloading stage ST0 in this manner is conveyed to the die assembling/disassembling unit 3 by the shaping-die conveying device 4.

As shown in FIG. 3A, when the shaping die D is conveyed to the die assembling/disassembling device 3, the shaping die D is fixed in a predetermined position of the mold table 31 while the lower mold D1 is being clamped by the lower clamping device 34 with the molds being closed. Here, in a state where the shaping die D is closed, the clearance between the upper mold D2 and the body mold D3 is set to the minimum (for example, about 0.5 to 2 μm) in order to increase a molding accuracy.

Then, as shown in FIG. 3B, when the optical lens L is to be removed from the mold by pulling the upper mold D2 off the body mold D3, the heating/temperature-retention device 32 is operated to heat the body mold D3 so that a temperature of the body mold D3 is increased higher than a temperature of the upper mold D2, to thereby provide a temperature difference (temperature gradient) therebetween.

Specifically, the temperature difference between the upper mold D2 and the body mold D3 is set to about 200° C., for example. The upper mold D2 can be removed smoothly if a temperature difference is set a range of 150° C. to 250° C. For example, even if such a strict molding accuracy is required that the clearance of the shaping die D should be set to 0.5 μm, the following relation is established so long as the temperature difference is set to 150° C. It is assumed that a coefficient of linear expansion of the molding material is α=5.2×10⁻⁶ and that an inner diameter of the body mold D3 is 10 mm. A total clearance (δ) can be given as

$$\begin{matrix}δ = 0.5 + 5.2 \times {10}^{- 6} \times 150 \times 10 \times {10}^{3} \\ = 8.3 [ µm ]\end{matrix}$$

Similarly, if the temperature difference is set to 250° C., a total clearance (δ) can be given as

$$\begin{matrix}δ = 0.5 + 5.2 \times {10}^{- 6} \times 250 \times 10 \times {10}^{3} \\ = 13.5 [ µm ]\end{matrix}$$

### As a result, the necessary clearance can be ensured.

In this manner, the upper mold D2 is clamped by the upper clamping device 35 and then lifted upward by the elevating device 33 under the condition that the temperature difference (including a temperature gradient) is provided by heating the body mold D3 so that the temperature of the body mold D3 is set higher than the temperature of the upper mold D2. Thereby, the upper mold D2 can be removed smoothly from the body mold D3 (see FIG. 3C).

That is, according to the glass molding machine 1 according to this embodiment, the heating/temperature-retention device 32 is provided in the die assembling/disassembling device 3 to provide the temperature difference so that the temperature of the body mold D3 is set higher than the temperature of the upper mold D2. Thus, the inner diameter of the body mold D3 as a hole side becomes larger than the outer diameter of the upper mold D2 as a core side due to a thermal expansion caused by this temperature difference. Therefore, the clearance between the body mold D3 and the upper mold D2 can be expanded.

As a result, not only a molding accuracy can be ensured by keeping a predetermined minimum clearance at a time of molding, but also the die assembling/disassembling operations can be carried out smoothly by expanding the clearance at a time of assembling/disassembling the mold.

Here, a timing at which the upper mold D2 is lifted up by the elevating device 33 becomes an issue. However, this timing giving the clearance through which the upper mold D2 is removed smoothly can be determined based on molding trials that are carried out in advance. Also, the upper mold D2 may be removed by heating the body mold D3 while the elevating device 33 applies a predetermined pull-out force in a direction along which the upper mold D2 is remove to such an extent that the sliding face is not engaged.

Then, the molded optical lens L is removed by the feeding/removing device 5 in a state where the upper mold D2 is removed (see FIG. 3D). Then, the glass material G for the subsequent molding is fed to the lower mold D1 by the feeding/removing device 5 (see FIG. 3E).

In this manner, according to the glass molding machine 1 of this embodiment, the glass material G is fed to the lower mold D1 and then the body mold D3 fitted to this lower mold D1 is heated. Therefore, a heat shock of the glass material G can be lessened by warming the lower mold D1 side to which the glass material G is fed.

Then, in a condition that the temperature difference (temperature gradient) is provided by heating the body mold D3 so that the temperature of the body mold D3 is set higher than the temperature of the upper mold D2, the elevating device 33 puts down the upper mold D2 to insert it into the body mold D3 to perform the die assembling (see FIG. 3F).

Next, a glass molding method according to the embodiment of the invention will be explained below with reference to FIGS. 2 and 3 mainly. In the following explanation, the same reference symbols are affixed to the configurations that are common to those in the glass molding machine 1, and therefore redundant explanations will be omitted herein.

A glass molding method according to the embodiment of the invention heats and molds a glass product L from a glass material G with using a shaping die D. The shaping die D includes a lower mold D1, an upper mold D2 and a body mold D3. The lower and upper molds D1, D2 are to be assembled with facing each other. The body mold D3 is to be fitted to exteriors of the lower and upper molds D1, D2 to position the lower and upper D1, D2. The method includes a die assembling step that feeds the glass material G to the lower mold D1 with the body mold D3 being fitted to the exterior of the lower mold D1 and fits the upper mold D2 into the body mold D3 to assemble the shaping die D; a glass molding step that heats and molds the glass material G; and a die disassembling step that removes the upper mold D2 from the body mold D3 after the molding, to remove the molded glass product G. In the assembling and disassembling steps, the assembling and the removing include providing a temperature difference so that a temperature of the body mold D3 is higher than a temperature of the upper mold D2.

As shown in FIGS. 3A to 3C, the die disassembling step is a step in which the upper mold D2 is removed smoothly from the body mold D3 by clamping the upper mold D2 by the upper clamping device 35 and lifting up it by the elevating device 33 in a condition that the body mold D3 is heated to provide a temperature difference (temperature gradient) so that a temperature of the body mold D3 is increased higher than a temperature of the upper mold D2.

As shown in FIG. 1, the glass molding step is a step that molds the optical lens L by the loading/unloading stage ST0 that loads/unloads the shaping die D (see FIG. 2), the heating stage ST1 that heats the shaping die D and the glass material G (see FIG. 2) fed into the cavity in the shaping die D, the pressurizing/molding stages ST2, ST3 that heat/mold the glass material G while pressurizing it, the slowly cooling stage ST4 that cures the glass material G while cooling it gradually, and the cooling stage ST5 that naturally cools a composition of the glass so as to stabilize it.

As shown in FIGS. 3E and 3F, the die assembling step is a step in which the glass material G is fed to the lower mold D1 by the feeding/removing device 5, and then the upper mold D2 is put down by the elevating device 33 and is pushed into the body mold D3 to perform the die assembling in a condition that the temperature difference (temperature gradient) is provided by heating the body mold D3 so that the temperature of the body mold D3 is set higher than the temperature of the upper mold D2.

The exemplary embodiments of the invention have been explained in detail with reference to the drawings as above. However, the invention is not limited to such embodiments, and the invention may be modified appropriately within a scope that does not depart from a gist of the invention.

For example, in this embodiment, the heating/retaining unit 32 which may serve as the heating/heat-retention device and which heats the body mold D3 is employed as the temperature controller. However, the invention is not limited to this configuration. A cooling device that cools the upper mold D2 by using a nitrogen gas or the like may be provided. Also, both the heating/temperature-retention device 32 that heats the body mold D3 and the cooling device that cools the upper mold D2 may be provided.

Also, in this embodiment, the body mold D3 is heated directly by the heating/temperature-retention device 32. However, the invention is not limited to this configuration. For example, the body mold D3 may be heated indirectly by heating the lower mold D1 by means of a hot plate in which a heater is built. According to such configuration, the influence of a shape and a size of the shaping die D can be reduced, and the body mold D3 can be heated with a simple configuration even when multiple products are molded simultaneously.

Also, in this embodiment, the timing giving the clearance through which the upper mold D2 can be lifted up by the elevating device 33 and the upper mold D2 can be removed smoothly is determined based on the molding trials that are carried out in advance. However, the invention is not limited to this configuration.

For example, a temperature sensor for sensing temperatures of the upper mold D2 and the body mold D3, which are to be fitted to each other may be provided to the die assembling/disassembling device 3. Then, the temperature of the upper mold D2 may be increased by sensing a temperature by means of this temperature sensor.

Also, a temperature adjusting device that adjusting a temperature difference by controlling the temperature controller based on a molding temperature sensed by the temperature sensor may be provided to manage a temperature difference.

What is claimed is:

1. A glass molding machine comprising:
a shaping die comprising
a first mold,
a second mold, the first and second molds to be assembled with facing each other, and
a body mold that is to be fitted to exteriors of the first and second molds to position the first and second molds, the glass molding machine that heats and molds a glass product from a glass material by using the shaping die;
a temperature controller;
a die assembling stage that feeds the glass material to the first mold with the body mold being fitted to the exterior of the first mold, the die assembling stage that fits the second mold to the body mold to assemble the shaping die;
a glass molding stage that heats and molds the glass material; and
a die disassembling stage that removes the second mold from the body mold after the molding, to remove the molded glass product, wherein:
the temperature controller provides a temperature difference so that a temperature of the body mold is higher than a temperature of the second mold in the die assembling stage and in the die disassembling stage.

2. The glass molding machine according to claim 1, wherein the first mold, the second mold and the body mold are formed of a molding material having a substantially identical coefficient of linear expansion.

3. The glass molding machine according to claim 1, wherein the temperature controller comprises a heating/heat-retention device that heats the body mold or keeps the temperature of the body mold.

4. The glass molding machine according to claim 1, wherein the temperature controller comprises a cooling device that cools the second mold.

5. The glass molding machine according to claim 1, wherein:
the first mold is a lower mold, and
the second mold is an upper mold.

6. A glass molding machine comprising:
a shaping die comprising
a first mold,
a second mold, the first and second molds to be assembled with facing each other, and
a body mold that is to be fitted to exteriors of the first and second molds to position the first and second molds, the glass molding machine that heats and molds a glass product from a glass material by using the shaping die;
a glass material feeding device that feeds the glass material to the first mold with the body mold being fitted to the exterior of the first mold;
a die assembling device that fits the second mold to the body mold to assemble the shaping die;
a heating/molding device that heats and molds the glass material using the shaping die assembled by the die assembling device;
a die disassembling device that removes the second mold from the body mold after the heating/molding device heats and molds, to disassemble the shaping die;
a glass product removing device that removes the glass product from the first mold and the body mold from which the second mold is removed; and
a shaping-die conveying device that carries the shaping die between (i) the die assembling device and the die disassembling device and (ii) the heating/molding device, wherein:
the die assembling device and the die disassembling device comprise a temperature controller that provides a temperature difference so that a temperature of the body mold is higher than a temperature of the second mold.

7. A glass molding method of heating and molding a glass product from a glass material with using a shaping die comprising
a first mold,
a second mold, the first and second molds to be assembled with facing each other, and
a body mold that is to be fitted to exteriors of the first and second molds to position the first and second molds,
the method comprising:
feeding the glass material to the first mold with the body mold being fitted to the exterior of the first mold and fitting the second mold into the body mold to assemble the shaping die;
heating and molding the glass material; and
removing the second mold from the body mold after the molding, to remove the molded glass product, wherein:
the assembling and the removing comprise providing a temperature difference so that a temperature of the body mold is higher than a temperature of the second mold.

8. The glass molding method according to claim 7, wherein the providing of the temperature difference comprises heating the body mold or keeping the temperature of the body mold.

9. The glass molding method according to claim 7, wherein the providing of the temperature difference comprises cooling the body mold.

10. The glass molding method according to claim 7, wherein:
the glass product is an optical element, and
the temperature difference is in a range of 150° C. to 250° C.

11. The glass molding method according to claim 7, wherein:
the first mold is a lower mold, and
the second mold is an upper mold.
